(19) United States
(12) Patent Application Publication
(10) Pub. No.: US 2023/0087819 A1
(43) Pub. Date: Mar. 23, 2023

(54) PHYSICAL LAYER CHIP AND ELECTRONIC DEVICE

(71) Applicant: ROHM CO., LTD., Kyoto-shi (JP)

(72) Inventors: Nozomu KOJA, Kyoto-shi (JP); Kenichi MOTOKI, Kyoto-shi (JP)

(21) Appl. No.: 17/903,437

(22) Filed: Sep. 6, 2022

(30) Foreign Application Priority Data
Sep. 10, 2021 (JP) 2021-147972

(51) Int. Cl. H02J 7/00

(52) U.S. Cl. CPC H02J 7/00034; H02J 2207/30

(57) ABSTRACT

The present disclosure relates to a physical layer chip and an electronic device. The physical layer chip is compatible with (Universal Serial Bus) USB Type-C standard and used in a device operable as a sink device. The physical layer chip includes an interface circuit, a transceiver, a non-volatile memory, a pin control circuit and an initial negotiation circuit. The interface circuit is communicable with an external main controller. The transceiver is communicable with a source device via a CC (Configuration Channel) pin. The non-volatile memory stores information required for an initial negotiation with the source device. The pin control circuit controls a state of the CC pin and monitors the state of the CC pin. The initial negotiation circuit is capable of performing the initial negotiation with the source device via the transceiver based on the information stored in the non-volatile memory.

### CROSS REFERENCES TO RELATED APPLICATIONS

The present invention claims priority under 35 U.S.C. § 119 to Japanese Application, 2021-147972, filed Sep. 10, 2021, the entire contents of which being incorporated herein by reference.

### TECHNICAL FIELD

The present disclosure relates to a power supply technique of an electronic device.

### BACKGROUND

A battery driven device represented by a cellphone terminal, a smartphone, a tablet terminal, a laptop computer or a portable audio player is built-in with a rechargeable secondary battery, and a charging circuit for charging the secondary battery. Regarding a charging circuit, a charging circuit that charges a secondary battery by supplying an external direct-current (DC) voltage (bus voltage V_{BUS}) through Universal Serial Bus (USB) or a DC voltage from an external alternating-current (AC) adaptor is available.

The USB Power Delivery (to be referred to as USB PD) standard is regulated for power supply devices and power supply system using USB. In the USB PD standard, power supply up to a maximum of 100 W is supported. The USB PD standard is also adopted by the USB Type-C standard.

In USB Type-C, the power supply side is referred to as a source, and the power receiving side is referred to as a sink. A device having a source function (a source role) is also referred to as a provider or a source device, and a device having a sink function (a sink role) is also referred to as a consumer or a sink device.

The configurations of USB ports in a sink device are generally divided into two types.

In the first configuration, a port controller integrated circuit (IC) in charge of control related to USB PD and Type-C is used. The port controller IC includes a microprocessor (processor) and is operable independently. The port controller IC has functions of detecting a source device solely based on a state of a Configuration Channel (CC) port and performing a negotiation via the CC pin.

The second configuration is used for a device having a microcontroller (main controller), which has remaining resources. In this configuration, processes and functions performed by the microprocessor in the port controller IC are installed in a main controller that is originally mounted for other purposes. In this case, a physical layer (PHY) chip providing a physical layer of USB Type-C is mounted as a peripheral circuit of a microcomputer. The physical layer chip is based on a Type-C port, a microcontroller and an interface (TCPCi).

FIG. 1 shows a block diagram of a configuration of a sink device having a physical layer chip. The sink device 10 includes a receptacle 12, a physical layer chip 14, a main controller 16, a bus switch SW1, a main power supply 18, a battery 20 and an auxiliary power supply 22. A USB cable is inserted in the receptacle 12. The receptacle 12 includes a VBUS (power supply) pin, a CC pin, and a GND (ground) pin.

A bus voltage VBUS from the source device is supplied to the VBUS pin. In the PD standard, the voltage level of the bus voltage VB_{U}S can be set through an initial negotiation, and varies within a range of 5 V to 20 V.

The physical layer chip 14 operates under the control of the main controller 16, detects the source device, and communicates with the source device. Moreover, the bus switch SW1 is turned on once the initial negotiation is complete.

In the USB PD standard, it is required to start the sink device 10 after charging the sink device 10 of which the battery 20 is in a fully discharged state (powerless battery state) from the source device. Such operation is referred to as a powerless battery operation.

The physical layer chip 14 is inoperable without the control from the main controller 16. The main controller 16 operates through a power supply voltage V_{DD1} generated by the main power supply 18. However, in the powerless battery state, a battery voltage V_{BAT} is insufficient, and the bus switch SW1 is also turned off, in a way that the main power supply 18 cannot generate the power supply voltage V_{DD1}. That is to say, in the powerless battery state, the main controller 16 is inoperable, and the physical layer chip 14 is inoperable as well.

To perform the powerless battery operation, the auxiliary power supply 22 is provided. Before the initial negotiation is complete, the bus voltage V_{BUS} at a predetermined voltage level (5 V) is supplied to the VBUS pin. The auxiliary power supply 22 uses the bus voltage V_{BUS} to generate a power supply voltage V_{DD2} for the main controller 16 and the physical layer chip 14. The main controller 16 is started by using the power supply voltage V_{DD2}, and the main controller 16 uses the physical layer chip 14 to perform the initial negotiation, accordingly, supplying the bus voltage V_{BUS} at a voltage level required by the sink device 10. Once the initial negotiation is complete, the main controller 16 can use the physical layer chip 14 to perform other negotiations.

### PRIOR ART DOCUMENT

### Patent Publication

[Patent document 1] Japan Patent Publication No. 6604863

### SUMMARY OF THE PRESENT DISCLOSURE

### Problems to be Solved by the Disclosure

The sink device 10 in FIG. 1 has a complicated configuration as having the auxiliary power supply 22 that is needed to perform the powerless battery operation.

The present disclosure is completed in view of the situation above, and in one aspect, aims to achieve an exemplary object of providing a powerless battery operation with a simpler structure.

### Technical Means for Solving the Problem

A physical layer (PHY) chip according to an embodiment relates to a physical layer chip, which is compatible with USB (Universal Serial Bus) Type-C standard and used in a device operable as a sink device. The physical layer chip includes: an interface circuit, communicable with an external micro controller; a transceiver, communicable with a source device via a configuration channel (CC) pin; a non-volatile memory, storing an information required for an initial negotiation with the source device; a pin control circuit, controlling a state of the CC pin and monitoring the state of the CC pin; and an initial negotiation circuit, capable of performing the initial negotiation with the source device via the transceiver based on the information stored in the non-volatile memory.

Moreover, an aspect obtained from any combination of the elements above, or an aspect obtained from conversions between expressions of methods and devices of the present disclosure may also effectively serve as an embodiment of the present disclosure.

### Effects of the Disclosure

According to an aspect of the disclosure, a powerless battery operation can be achieved.

### BRIEF DESCRIPTION OF THE DRAWINGS

FIG. 1 is a block diagram of a configuration of a sink device having a physical layer chip.

FIG. 2 is a block diagram of an electronic device having a physical layer chip according to an embodiment.

FIG. 3 is a block diagram of a physical layer chip according to an embodiment.

### DETAILED DESCRIPTION OF THE EMBODIMENTS

### (Summary of Embodiments)

A summary of several embodiments of the present disclosure is given below. The summary serves as the preamble of the detailed description to be given below and aims to provide fundamental understanding of the embodiments by describing several concepts of one or more embodiments in brief. It should be noted that the summary is not to be construed as limitations to the scope of the present disclosure. The summary is not a general summary of all conceivable embodiments, nor does it intend to specify important elements of all embodiments or to define the scope of a part of or all aspects. For the sake of better description, “one embodiment” sometimes refers to one embodiment (implementation example or variation example) or multiple embodiments (implementation examples or variation examples).

A physical layer (PHY) chip according to an embodiment is compatible with USB (Universal Serial Bus) Type-C standard and is used in a device operable as a sink device. The physical layer chip includes: an interface circuit, communicable with an external main controller; a transceiver, communicable with a source device via a configuration channel (CC) pin; a non-volatile memory, storing an information required for an initial negotiation with the source device; a pin control circuit, controlling a state of the CC pin and monitoring the state of the CC pin; and an initial negotiation circuit, capable of performing the initial negotiation with the source device via the transceiver based on the information stored in the non-volatile memory.

According to the configuration, in a powerless battery state, the initial negotiation can be performed even without control from the external main controller. Since it is not required to activate the main controller for the initial negotiation, no auxiliary power supply is needed.

In one embodiment, the initial negotiation circuit may include a hardware logic. The initial negotiation for performing power setting between the source and sink device takes place when the source device becomes a bus master device, so the sink device can respond as a slave device. Thus, by forming the initial negotiation circuit using the hardware logic instead of forming the initial negotiation circuit using a combination of a processor and a software application, costs can be reduced.

In one embodiment, the physical layer chip may further include a power supply pin directly connected to a VBUS pin of a receptacle of the device.

### (Embodiments)

Details of appropriate embodiments are given with the accompanying drawings below. The same or equivalent constituting elements, parts and processes are represented by the same denotations, and repeated description is omitted as appropriate. Moreover, the elements are non-limiting to the present disclosure but are exemplary. All features and combinations thereof described in the embodiments are not necessarily intrinsic features of combinations of the present disclosure.

In the description of the application, an expression “a state of component A connected to component B” includes, in addition to a situation where component A and component B are directly connected, a situation where component A is indirectly connected to component B via another component, without the another component resulting in substantial influences on their electrical connection or impairing functions or effects exerted by their connection.

Similarly, an expression “a state of component C connected (disposed) between component A and component B” includes, in addition to a situation where component A and component C, or component B and component C are directly connected, a situation where they are indirectly connected via another component, without the another component resulting in substantial influences on their electrical connection or impairing functions or effects exerted by their connection.

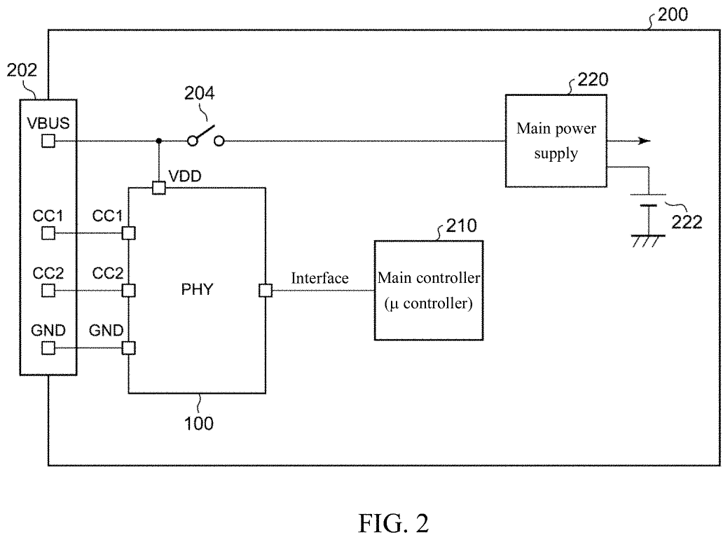

FIG. 2 shows a block diagram of an electronic device 200 having a physical layer (PHY) chip 100 according to an embodiment. The electronic device 200 includes the physical layer chip 100, a receptacle 202, a bus switch 204, a main controller 210, a main power supply 220 and a battery 222. In addition to including the modules shown herein, the electronic device 200 further includes modules corresponding to intrinsic functions. The electronic device 200 can become a consumer in the USB Type-C standard and can be powered by a source device. The main power supply 220 may include a charging circuit, which charges the battery 222 using power from the source device.

The receptacle 202 includes a VBUS pin, a CC1 pin, a CC2 pin and a GND pin. In the receptacle 202, a target device is connected through a USB cable.

The bus switch 204 is inserted between the VBUS pin and the main power supply 220. Once an initial negotiation between the electronic device 200 and the target device is completed, the bus switch 204 is turned on to supply a bus voltage VBUS to the main power supply 220.

The main controller 210 includes a processor that universally controls the electronic device 200, and includes, for example, a micro controller or a system-on-chip (SoC). In addition to the function of controlling the electronic device 200, the main controller 210 further performs a negotiation function under the USB Type-C standard. The negotiation is performed by the physical layer chip 100.

The physical layer chip 100 is a functional integrated circuit (IC) including a power supply pin VDD, a configuration channel (CC) pins CC1 and CC2, a ground pin GND and an interface pin IF. The power supply pin VDD, the ground pin GND, the CC1 pin and the CC2 pin are connected to corresponding pins of the receptacle. The interface pin IF is connected to the main controller 210. The main controller 210 uses the physical layer chip 100 to perform the negotiation with the target device. A physical layer and a logical layer (protocol) need for communicating with the target device are installed in the physical layer chip 100, and the main controller 210 receives data from the target device via the physical layer chip 100 and further transmits data that is to be transmitted to the target device to the physical layer chip 100.

The overall configuration of the electronic device 200 is described above. The configuration of the physical layer chip 100 is to be described below.

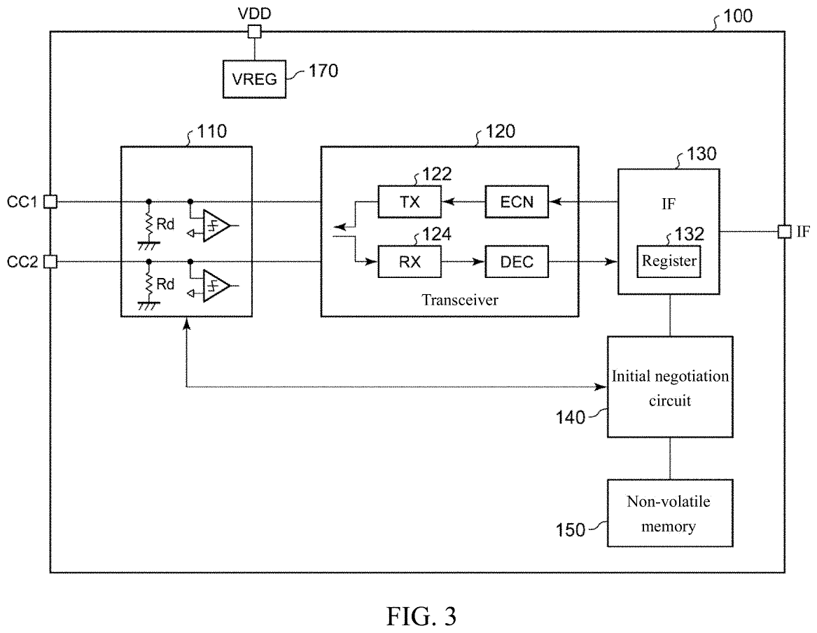

FIG. 3 shows a block diagram of the physical layer chip 100 according to one embodiment. The physical layer chip 100 is compatible with the Universal Serial Bus (USB) Type-C standard. As shown in FIG. 2, the physical layer chip 100 can be used in an electronic device operable as a sink device and is installed with a physical layer and a logical layer.

The physical layer chip 100 has a pin control circuit 110, a transceiver 120, an interface circuit 130, an initial negotiation circuit 140, a non-volatile memory 150 and an internal power supply 170.

The pin control circuit 110 is a front-end module connected to the CC1 pin and the CC2 pin, and controls states of the CC1 and CC2 pins, and monitors the state of theses CC pins.

The role (source/sink) of the electronic device 200 is determined according to the states (pulled up or pulled down) of the CC1 pin and the CC2 pin. The pin control circuit 110 includes hardware (for example, a pull-down resistor Rd) for specifying the role of the electronic device 200, or hardware (for example, a voltage comparator) for determining a role of a target device. The internal configuration of the pin control circuit 110 may be implemented by commonly techniques, and such description is thus omitted.

The transceiver 200 communicates according to a start of packet (SOP), and has a transmitter 122, a receiver 124, an encoder 126 and a decoder 128. The encoder 126 and the decoder 128 are compatible with biphase mark coding (BCM). The encoder 126 encodes data generated by the main controller 210, and the transmitter (a line driver) 122 transmits encoded signals. Signals received by the receiver 124 are decoded by the decoder 128.

The interface circuit 130 is communicable with the main controller 210. The interface circuit 130 provides data communication between the transceiver 120 and the main controller 210. The type of the interface circuit 130 is not specifically defined, and such as inter-integrated circuit (I²C) or serial peripheral interface (SPI) may be used. In FIG. 3, one IF (interface) pin is depicted. The IF pin in brief represents a clock terminal SCL and a data terminal SDA in the I²C interface, and briefly represents a chip selection terminal CS, a clock terminal SCLK, a data input terminal SDI and a data output terminal SDO in the SPI.

The interface circuit 130 may include a register 132. The main controller 210 communicates with the interface circuit 130 and writes data to the register 132. The transceiver 120 reads the data that the main controller 210 writes to the register 210 and sends the data to a counterpart device (source device).

Moreover, the data that the transceiver 120 receives from the source device is written to the register 132. The main controller 210 is, by accessing the register 132, capable of reading data that the transceiver 120 receives from the source device.

The non-volatile memory 150 stores information required for the initial negotiation with the source device. The information is intrinsic information of the electronic device 200, and specifically, can include power data demanded by the electronic device 200. The form of the power data is not specifically defined and may be in a form selected from multiple power data objects (PDOs) below. For example, the power data may include a list of the required bus voltage V_{BUS} and current.

The initial negotiation circuit 140 is configured to be capable of performing the initial negotiation with the source device via the transceiver 120 based on the information stored in the non-volatile memory 150.

The internal power supply 170 is connected to the VDD (power supply voltage) pin, and receives the bus voltage V_{BUS}. The internal power supply 170 generates and supplies a stabilized power supply voltage V_{REG} to at least one module in the physical layer chip 100.

The configuration of the physical layer chip 100 is described above. The operation of the physical layer chip 100 is to be described below.

### 1. Initial State

In the initial state, the battery 222 is fully discharged, and the electronic device 200 is inoperable. In this state, a device having a source function is connected to the receptacle 202 through a USB cable.

### 2. Establishment of Source-to-Sink Relationship

A target device to become the source device establishes a connection with a sink device based on the states of the CC1 and CC2 pins. More specifically, the target device determines according to the presence of the pull-down resistor Rd included in the electronic device 200 whether the electronic device 200 is a sink device. When the target device detects the presence of the pull-down resistor Rd and determines the electronic device 200 as a sink device, a connection is regarded as established, and it outputs the predetermined 5 V bus voltage V_{BUS}.

The bus voltage V_{BUS} output by the target device is supplied to the power supply pin VDD of the physical layer chip 100, thereby enabling the physical layer chip 100 to operate. The physical layer chip 100 of the electronic device 200 determines that the target device is a source device based on the states of the CC1 and CC2 pins. More specifically, the pin control circuit 110 of the physical layer chip 100 detects a boost resistance Rp of the counterpart based on the voltages of the CC1 pin and the CC2 pin. The pin control circuit 110 determines that the connection with the counterpart is established under conditions that the bus voltage V_{BUS} is supplied and the boost resistor Rp of the target device is detected. The boost resistor Rp of the target device (source device) differs depending on current values (3 A, 1.5 A, 500 mA). The CC pins generate a voltage divided according to Rp and Rd, and so the pin control circuit 110 can detect a resistance value of the boot resistor Rp, that is, a current value, according to the voltage of the CC pins.

The process up to this point does not involve communication of the CC pins.

### 3. Initial Negotiation (Power Supply Negotiation)

The initial negotiation is to be performed next. In this phase, the main controller 210 is not yet started. The target device determines whether the electronic device 200 is compatible with USB PD. The target devices communicate by using a CC line and transmits a data packet (source-capabilities) included therein and corresponding to the PDO to the electronic device 200. The PDO specifies combinations of a voltage and a current that can be supplied thereby. When the electronic device 200 is compatible with USB PD, the electronic device 200 returns a response to the PDO from the target device. When the electronic device 200 is not compatible with USB PD, no response with respect to the PDO is returned, and so that target device can accordingly determine that the electronic device 200 is not compatible with USB PD.

The transceiver 120 of the electronic device 200 receives the data packet including the PDO. The initial negotiation circuit 140 is notified of the PDO included in the received data packet. Data transmission between the transceiver 120 and the initial negotiation circuit 140 can be performed using the register 132 of the interface circuit 130.

In the non-volatile memory 150, power data of power (voltage and current) required by the electronic device 200 is stored. The initial negotiation circuit 140 selects one of a plurality of PDOs based on the power data stored in the non-volatile memory 150, and then returns an identifier (serial number) representing the selected PDO to the transceiver 120. The transceiver 120 sends the data packet (request message) including the identifier of the PDO to a source device 400 serving as the target device.

Upon receiving the request message, the target device determines the voltage and current to be supplied based on the data included in the request message. Then, the voltage level of the bus voltage VBUS is set to a voltage level determined by the negotiation.

Once the initial negotiation is completed, when the main controller 210 is started, the negotiation between the electronic device 200 and the target device is handed to the main controller 210. For example, when the electronic device 200 can exchange between both roles of a host and a source, it needs to be compatible with the protocol for role exchange of power supply. The function of the negotiation associated with switching of the role exchange of power supply is installed in the main controller 210 (software application) and is not installed in the physical layer chip 100.

Moreover, in USB PD3.0 options, a standard referred to as program power supply (PPS) is specified. When the electronic device 200 is compatible with PPS, related functions of communication associated with PPS are installed in the main controller 210 (software application).

The operations of the physical layer chip 100 and the electronic device 200 are as described above.

According to the physical layer chip 100, with the built-in initial negotiation circuit 140, the initial negotiation can be performed without starting the main controller 210. A result of the initial negotiation is that, when the target device supplies power sufficient enough for operating the electronic device 200, the main power supply 220 operates and the main controller 210 is started. Moreover, the battery 222 is charged.

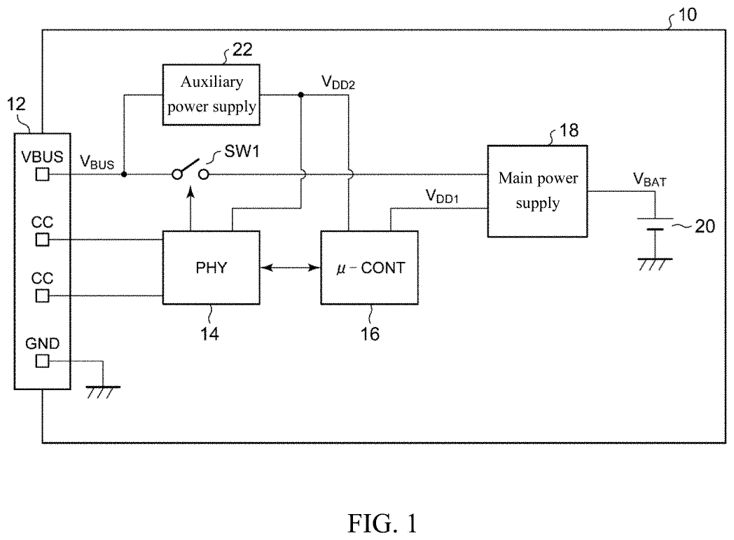

Referring to FIG. 1, the auxiliary power supply 22 is needed in a conventional configuration. However, in this embodiment, as shown in FIG. 2, an auxiliary power supply used for a start from a powerless battery state is not needed. Thus, the configuration of the electronic device 200 can be simplified to reduce costs.

The initial negotiation function installed in the physical layer chip 100 selects one simple function from multiple PDOs and can thus be installed using a simple hardware logic. Therefore, the chip area of the physical layer chip 100 is minimally increased.

While the embodiments are exemplary, a person skilled in the art would be able to understand that there are various variation examples of combinations of the constituting elements and processes of these embodiments. Details of such variation examples are given in the description below.

### (Various Embodiment 1)

In some embodiments, situations where a hardware logic forms the initial negotiation circuit 140 are illustrated; however, the present disclosure is not limited to such example. For example, installation also be implemented by small-scale and entry-function-level processors and software applications.

### (Various Embodiment 2)

In some embodiments, the function of the source is described in focus with regard to the physical layer chip 100. However, the physical layer chip 100 can correspond to both roles, and in this case, the pin control circuit 110 is added with a component (boost resistor Rp) or a comparator and a VCONN voltage generating circuit associated with the sink.

### (Various Embodiment 3)

In FIG. 3, the initial negotiation circuit 140 exchanges data with the transceiver 120 by using the register 132 of the interface circuit 130; however, the present disclosure is not limited to such example. Another path for transmitting and receiving data may also be added between the transceiver 120 and the initial negotiation circuit 140.

### (Various Embodiment 4)

In FIG. 2, the VDD pin of the physical layer chip 100 is connected so as to be directly supplied with the bus voltage V_{BUS} from the VBUS pin; however, the present disclosure is not limited to such example. The VDD pin of the physical layer chip 100 may also be connected so as to be supplied with the supply voltage from the main power supply 220 during the operation of the main power supply 220.

### (Various Embodiment 5)

In the embodiments, the bus switch 204 is turned on once the negotiation is completed; however, the present disclosure is not limited to such example. For example, when the power supply voltage needed by the main power supply 220 is 5 V, the bus switch 204 may be turned on before the negotiation is completed. When the source is not compatible with PD, only 5 V can be supplied. However, in this case, the system can be started when the voltage needed by the main power supply 220 is 5 V.

While the embodiments are exemplary, a person skilled in the art would be able to understand that there are various variation examples of combinations of the constituting elements and processes of these embodiments, and such variation examples are to be encompassed within the present disclosure or the scope of the present disclosure.

1. A physical layer chip, compatible with USB (Universal Serial Bus) Type-C standard and used in a device operable as a sink device, the physical layer chip comprising:
an interface circuit, communicable with an external main controller;
a transceiver, communicable with a source device via a CC (Configuration Channel) pin;
a non-volatile memory, storing an information required for an initial negotiation with the source device;
a pin control circuit, controlling a state of the CC pin and monitoring the state of the CC pin; and
an initial negotiation circuit, capable of performing the initial negotiation with the source device via the transceiver based on the information stored in the non-volatile memory.

2. The physical layer chip of claim 1, wherein the initial negotiation circuit includes a hardware logic.

3. The physical layer chip of claim 1, further comprising a power supply pin directly connected to a VBUS pin of a receptacle of the device.

4. An electronic device, compatible with USB Type-C standard and used in a device operable as a sink device, the electronic device comprising:
a receptacle,
a main controller; and
the physical layer chip of claim 1.

5. An electronic device, compatible with USB Type-C standard and used in a device operable as a sink device, the electronic device comprising:
a receptacle,
a main controller; and
the physical layer chip of claim 2.

6. An electronic device, compatible with USB Type-C standard and used in a device operable as a sink device, the electronic device comprising:
a receptacle,
a main controller; and
the physical layer chip of claim 3.
